(19) United States
(12) Patent Application Publication
(10) Pub. No.: US 2004/0158626 A1
(43) Pub. Date: Aug. 12, 2004

(54) Method and apparatus for monitoring data flow to a router

(76) Inventor: Christopher Paul Douglas, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/361,592

(22) Filed: Feb. 11, 2003

(51) Int. Cl. G06F 15/173

(52) U.S. Cl. 709/224; 709/238

(57) ABSTRACT

A method for monitoring data flow to a router having an interface configured to receive media streams, includes identifying media streams directed to the interface, and determining whether a combined data flow rate of the identified media streams exceeds a threshold. A streaming server can provide information about media streams emanating from the streaming server, for example a router destination and a flow rate for each stream emanating from the streaming server. The threshold can be based on a speed of the interface, and the router can be a first-hop router with respect to the streaming servers providing media streams to the router's interface. The method can include determining what portion of the interface capacity is consumed by the media streams.

### BACKGROUND

In networks where one or more streaming servers provides one or more media streams to first-hop routers, network monitoring solutions do not indicate how the media streams affect performance of the first-hop routers. First-hop routers are the first routers that the media streams encounter after departing the streaming servers. For example, a first-hop router is the first router encountered when determining the path (a set of routers) that an IP (Internet Protocol) packet will travel, and is the first router used by a source computer when sending information to a remote IP network.

U.S. Pat. No. 6,249,755, U.S. Pat. No. 5,661,668 and U.S. Pat. No. 5,528,516 describe methods for determining problem sources in a complex system of managed components based upon symptoms or observable events.

Hewlett Packard's OpenView™ Network Node Manager monitors router interfaces, including total flow of data (without distinguishing data type) through router interfaces.

### SUMMARY

An exemplary method for monitoring data flow to a router having an interface configured to receive media streams includes identifying media streams directed to the interface, and determining whether a combined data flow rate of the identified media streams exceeds a threshold. A machine readable medium can include software for causing a computing device to perform the exemplary method. An exemplary system for monitoring data flow to a router having an interface configured to receive media streams, includes an agent arranged to identify media streams directed to the interface, and a device arranged to receive information regarding media streams identified by the agent, from the agent and to determine whether a combined data flow rate of the identified media streams exceeds a threshold. An exemplary system for monitoring streaming media flow to a router having an interface configured to receive media streams, includes a plurality of means for collecting information associated with streaming servers where the information includes destination and flow rate information about media streams emanating from the streaming servers, means for determining based on the collected information, a combined data flow rate of all identified media streams directed to the interface, and means for determining whether the combined data flow rate exceeds a threshold.

### BRIEF DESCRIPTION OF THE DRAWINGS

Other objects and advantages will become apparent to those skilled in the art from the following detailed description of preferred embodiments, when read in conjunction with the accompanying drawings wherein like elements have been designated with like reference numerals and wherein:

FIG. 1 illustrates a method and mechanism for monitoring a network in accordance with an exemplary embodiment.

FIG. 2 illustrates operation of a management server shown in FIG. 1 in accordance with an exemplary embodiment.

FIGS. 3A-3B illustrate operation of agents shown in FIG. 1 in accordance with an exemplary embodiment.

FIG. 4 illustrates an examplary Router Interface Streaming Usage Report in accordance with an exemplary embodiment.

### DETAILED DESCRIPTION OF THE EXEMPLARY EMBODIMENTS

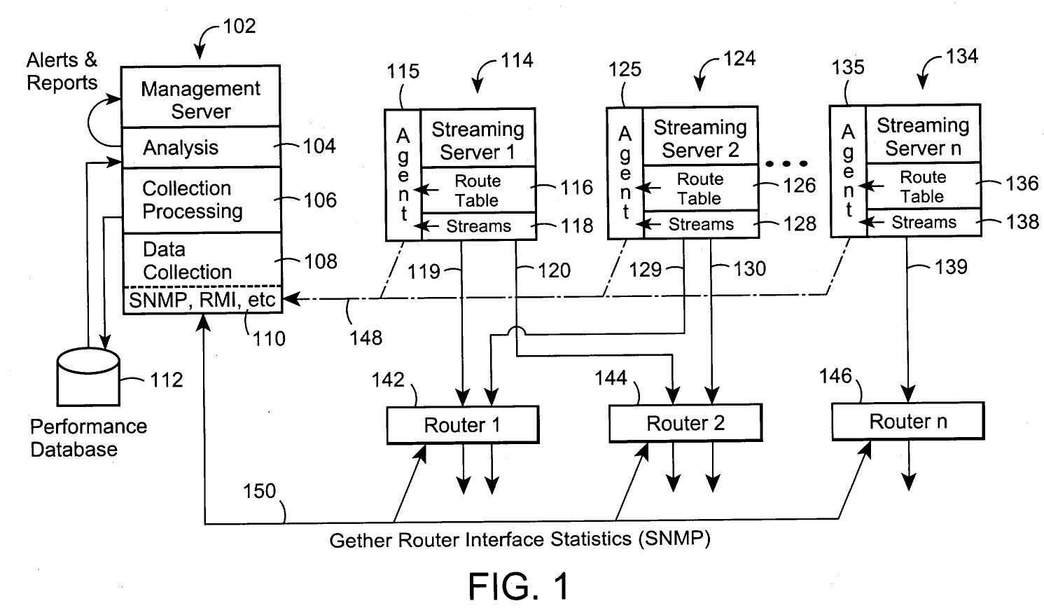

FIG. 1 illustrates an exemplary system architecture and method, for monitoring data flow, such as media streams emanating from streaming servers, to a router such as the routers 142, 144, 146, each having an interface configured to receive media streams such as the media streams 119, 120, 129, 130, 139 emanating from the streaming servers 114, 124, 134. In accordance with exemplary embodiments, media streams directed to the interfaces are identified (that is, data content supplied to an interface can be distinguished as streaming media based on its source, or based on information about or from its source). In an exemplary embodiment, for each of a plurality of the interfaces or routers, a determination can be made whether a combined data flow rate of the identified media streams from one or more sources to the router or interface exceeds a threshold. The threshold can be specified by, for example, a maximum speed and/or capacity of the router interface, or fractions or percentages thereof. The routers 142, 144, 146 can be first-hop routers with respect to the media streams 119, 120, 129, 130, 139.

The agents 115, 125, 135 monitor the media streams emanating from the streaming servers 114, 124, 134. In accordance with exemplary embodiments, data output from each streaming server is mapped, at the server, to an interface(s) of a router(s) so that media streams or streaming media in the data supplied by each streaming server to the interface(s) can be identified and/or monitored. For example, the agents 115, 125 can collect information associated with the streaming servers 114, 124 for example a) information from the routing or route tables 116, 126 indicating that the media streams 119, 129 from the streaming servers 114, 124 are directed to the router 142 or its interface, and b) information 118, 128 from the streaming servers 114, 124 about the media streams 119, 129. The information from the route tables can include router destinations of the media streams emanating from the streaming server. The information 118, 128 about the media streams can include data flow rates of the media streams.

As used herein, a route table or routing table is a table resident on a computer system that maps remote IP networks to routers that can be used to reach those networks. Below is an example route table retrieved from a Microsoft Windows 2000™ system using the netstat-rn command:

Route Table
Interface List

0x1 MS TCP Loopback interface
0x2 . . . 44 45 53 54 42 00 NOC Extranet Access Adapter
0x1000004 . . . 00 00 86 40 e9 32 3Com 10/100 Mini PCI
Ethernet Adapter

Active Routes:

| | | | | Met- |
|---|---|---|---|---|
| Network Dest. | Netmask | Gateway | Interface | ric |
| 0.0.0.0 | 0.0.0.0 | 15.2.112.1 | 15.2.114.197 | 1 |
| 15.2.112.0 | 255.255.248.0 | 15.2.114.197 | 15.2.114.197 | 1 |
| 15.2.114.197 | 255.255.255.255 | 127.0.0.1 | 127.0.0.1 | 1 |
| 15.255.255.255 | 255.255.255.255 | 15.2.114.197 | 15.2.114.197 | 1 |
| 127.0.0.0 | 255.0.0.0 | 127.0.0.1 | 127.0.0.1 | 1 |
| 192.0.0.0 | 255.255.255.0 | 15.2.113.226 | 15.2.114.197 | 1 |
| 224.0.0.0 | 224.0.0.0 | 15.2.114.197 | 15.2.114.197 | 1 |
| 255.255.255.255 | 255.255.255.255 | 15.2.114.197 | 2 | 1 |
| Default Gateway: | 15.2.112.1 | | | |

Persistent Routes:

| Network Address | Netmask | Gateway Address | Metric |
|---|---|---|---|
| 192.0.0.0 | 255.255.255.0 | 15.2.113.226 | 1 |

The agents 115, 125, 135 monitor the various media streams emanating from the streaming servers 114, 124, 134 in the same fashion described above with respect to the agents 115, 125 and the streams 119, 129. For example, the agents 115, 125, 135 monitor the media streams 120, 130, 139 emanating from the streaming servers 114, 124, 134 and variously directed to the different routers 142, 144, 146. The agents 115, 125, 135 can be implemented as software entities that run respectively on the streaming servers 114, 124, 134. An agent runs on a streaming server, and determines the streaming impact for that server on various first-hop routers by querying the streaming subsystem of the streaming server and accessing the routing table of the streaming server to assemble data regarding the size (e.g., data flow rate) of and first-hop destinations of the media streams. The data assembled by an agent can be organized in an Impact Table containing, for example, entries for each first-hop router that receives a media stream from the streaming server, including an IP address of the router, a number of streams emanating from the streaming server to the first-hop router, and a combined data flow rate of the streams.

Each of the streaming servers 114, 124, 134 can include a Streaming System, which as used herein is a core application running on the streaming server. The Streaming System application can accept requests from clients who desire to view streaming media, can load streaming media files from disk or other storage, and can play a streamed media file by sending the file contents at an encoded bit rate to the requesting client. The bit rate can correspond to the desired resolution of the file, for example, and can be constant for the duration of the stream.

The agents 115, 125, 135 (or the streaming servers on which they run) provide the collected information (e.g., in the form of Impact Tables) to a device that is arranged to receive and analyze the information, for example the management server 102, via a link 148. The link 148 can be implemented in a variety of ways, including via SNMP (Simple Network Management Protocol), via RMI (Remote Method Invocation), and so forth.

The management server 102 can also receive or actively collect information from each of the routers 142, 144, 146 via a link 150, which can for example be an SNMP-based link. The information received from the routers 142, 144, 146 can include, for example, a maximum capacity and/or speed of the router and/or its interface, a current load or data flow through the router, history/statistics about performance of the router interfaces, and so forth. Information from the routers can be used to establish threshold values associated with the routers.

The management server 102 can combine information received from the agents with respect to a router to determine a combined data flow rate of the media streams to that router, and then compare the combined data flow rate against a threshold associated with that router or its interface. The threshold can include a maximum speed and/or capacity of the router interface, or percentages thereof.

The management server 102 can include an interface section 110 for interfacing/communicating with the agents 115, 125, 135 and the routers 142, 144, 146. The management server 102 can also include a data collection module or collection capability 108, a collection processing module or capability 106, and an analysis module or analysis capability 104. The collection processing module can, for example, collate or aggregate information contained in impact tables received from the agents 115, 125, 135 with respect to each of the routers 142, 144, 146. The analysis module 104 can process the aggregated information to determine a total streaming media flow rate for each of the routers 142, 144, 146, and can determine whether the total streaming media flow rate directed to one of the routers 142, 144, 146 and/or its interface exceeds a threshold associated with router and/or interface. For example, the analysis module 104 can also determine what portion of the combined data flow rate emanates from a particular one of the streaming servers, and can determine a contribution of each streaming server to the combined data flow rate. Those skilled in the art will appreciate that these modules can be implemented as software modules or hardware modules, or any combination thereof to form the management server 102. The modules or capabilities can be integral components of the management server 102, or can be external resources that the management server 102 accesses or invokes. The management server 102 can be implemented with central processing, and/or distributed processing, and so forth. The management server 102 can also store data relating to its activities (including activities of or relating to the capabilities or modules mentioned above) in a data storage unit 112 such as a database. As indicated in FIG. 1, the management server 102 can also generate alerts and reports based on the information received from the agents 115, 125, 135 and/or the routers 142, 144, 146.

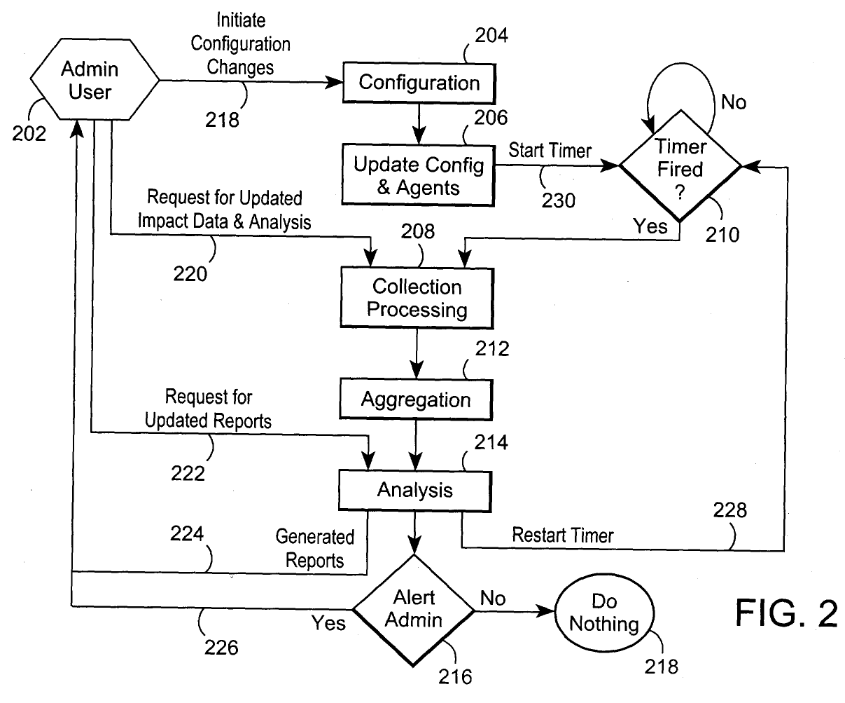

FIG. 2 illustrates detailed operations of an exemplary configuration of the management server 102. As shown in FIG. 2, an administrator 202 can initiate various actions by the management server 102, including Initiate Configuration Changes 218, Request Updated Impact Data & Analysis 220, and Request Updated Reports 222. These actions can also be performed automatically, for example when triggered by a timer, or by certain conditions (e.g., upon occurrence of a predetermined condition, for example receipt of new information from one or more of the agents 115, 125, 135 and/or the routers 142, 144, 146, or any other relevant condition or conditions), and can be triggered from within or without the management server 102. The administrator 202 can be a human operator or user, an autonomous supervisory program, or a program directed or supervised by a human operator.

In block 204, the administrator obtains or establishes configuration information for the management server 102 and the agents 115, 125, 135. The configuration information can include a list of streaming servers to manage, settings for streaming filters and router filters that the agents 115, 125, 135 will apply, and a collection start time and a collection interval.

The collection start time can indicate a time at which the first collection should occur, and the collection interval can indicate a frequency at which the collections should occur. For example, the collection interval can be selected to have a value between 15 and 60 minutes, and can be constrained by a minimum value of 5 minutes, and an unlimited maximum value. The collection interval can have any other value and/or limits. In an exemplary embodiment, the collection start time and the collection interval are common across all agents to ensure consistency of the data presented to the administrator, for example by the management server 102. The collection interval can define a) when the agents will run to gather information, and can define b) when a Management Server Collection Processing phase will run to collect the information from the agents. In an exemplary embodiment, the collection of information by the management server 102 from the agents 115, 125, 135 can run one minute after the agents 115, 125, 135 complete their collection of information from the streaming servers 114, 124, 134.

The configuration information can also specify a format in which the agents 115, 125, 135 will or should return information to the management server 102. For example, each agent can return information (including, for example, information about media streams emanating from a streaming server) to the management server 102 regarding the streaming server on which the agent is running and/or which the agent is monitoring. The information can be in the form of an exemplary Impact Table shown below. The Impact Table can include a list of routers receiving one or more media streams from the streaming server, and for each router in the list, an IP address of the router, the number of media streams directed from the streaming server to the router, and a bit rate indicating the combined data flow rate of the media streams from the streaming server to the router:

| Router IP Address | Total Bit Rate (Kbit/s) | Number of Streams |
|---|---|---|
| 15.2.112.1 | 600 | 2 |
| 15.34.12.1 | 1024 | 34 |
| 15.10.240.1 | 2048 | 10 |

As used herein, “bit rate” means the number of bits per second at which a data stream is sending information. This can also refer to the encoded bit rate for streamed media file(s). In other words, the bit rate can reflect the number of bits per second that will be sent while the streaming media file is being “played”. This can also be a direct indication of the quality (e.g., resolution) of the streaming media file, in situations where quality increases with bit rate.

Those skilled in the art will also recognize that the Impact Table can include more or less granularity or detail of information, and the information can be ordered or structured in different ways. For example, the Impact Table can be modified to omit the number of streams, and/or to include stream names, and so forth. The Impact Table can include information about streams emanating from a streaming server, including for example the number of streams, the data flow rate of each stream, the destination of each stream (e.g., the IP address of a first router the stream is directed to), the total data flow rate of streams to each destination, and so forth. Those skilled in the art will recognize that the agents can return such information to the management server in a variety of forms or techniques, including but not limited to Impact Tables as described above. Thus, where Impact Tables are mentioned in this document, other forms, data structures or mechanisms can be substituted for, or used in addition to, Impact Tables, to return information from the agents to the management server, for example information about streams and/or the routers to which they are directed.

The configuration information can also include thresholds to be checked and reports to be generated during an Analysis phase when the management server 102 evaluates the data it has collected from the agents 115, 125, 135 and/or the routers 142, 144, 146.

An examplary configuration file is shown below:

```
# Example Config File:
# Aggregated First Hop Router Streaming Impact Determination
# Note, The ‘#’ character indicates a comment line.
# Set Start Time and Interval for generating the “Impact Table”
# Value for START TIME is a 24-hour clock
START TIME: 12:00
# Value for INTERVAL is in minutes
INTERVAL: 30
# Filters section
# Filters allow you to limit or constrain the data collected.
# Filters are processed in the order listed below
#
# Filter Types
# STREAM NAME: <list of names>
# Stream file names to include/exclude in the monitoring.
# Multiple names must each be separated by a comma.
# A plus ‘+’ placed in front of a name indicates that it should
      be monitored.
# A dash ‘−’ placed in front of a name indicates it should
      not be monitored.
# If the list is empty, then ALL streams are included
      (should be monitored)
# STREAM SIZE: <value>
# Limit analysis to only streams encoded to a Bit Rate >= the value.
# If empty, then include ALL streams that pass the STREAM
      NAME filter.
# ROUTER ADDRESS: <list of IP addresses>
# Routers to include/exclude in the monitoring, specified
      by IP address.
# Multiple IP addresses must each be separated by a comma.
# A plus ‘+’ in front of an IP address indicates it should be
      monitored.
# A dash ‘−’ in front of an IP address indicates that it
      should not be monitored.
# If empty, then ALL IP addresses are included.
STREAM NAME: +MaryPoppins.wmt, +Mat.wmt,
+Pokemon.wmt, −MASH.wmt
STREAM SIZE: 300
ROUTER INCLUDE: +15.2.112.1, +15.34.12.1, +15.10.240.1,
−15.8.84.137
```

The filters can allow the administrator flexibility to focus on specific streams and/or routers, and/or to ignore specific streams and/or routers. The filters can also be arranged to apply size thresholds, so that streams are monitored based on whether their size exceeds a threshold, or is less than a threshold. Such tests as this threshold test can be combined with other filtering criteria to form a boolean or other logical combination of filtering criteria, so that when a stream satisfies this logical filter combination it will be monitored (or not monitored). The filters can be open (passing all streams, routers) or omitted.

In block 206 of FIG. 2, the configuration information is applied to update the configurations of the agents 115, 125, 135 and/or the management server 102. This can include either manually or automatically deploying the agents 115, 125, 135 to the streaming servers 114, 124, 134. Deployment of the agents can be done via FTP (File Transfer Protocol), via Remote Disk Drive Mounts (Also known as “shares”), via third party software installers, and so forth.

From block 206, the Start Timer is started in an action 230, and in block 210 when the Start Timer fires or times out, control proceeds to block 208 where collection processing is performed. Block 208 can also be entered via (or in response to) the action Request for Updated Impact Data and Analysis 220.

In block 208, the management server 102 collects data from the agents 115, 125, 135. For example, a data collector routine or agent of the management server 102 can request information (e.g., impact tables) from the agents 115, 125, 135 that were deployed to the configured remote streaming servers 114, 124, 134. The requests can be made, for example, using RMI (Remote Method Invocation), CORBA (Common Object Request Broker Architecture (Object Management Group)), SNMP (Simple Network Management Protocol) or other suitable mechanisms. Collection processing can continue until an Impact Table has been collected from each configured remote streaming server 114, 124, 134 (e.g., via the agents 115, 125, 135).

After data are collected in block 208, the data can be aggregated in block 212. In this process or method, the management server 102 combines or organizes data received from the agents 115, 125, 135 and/or the routers 142, 144, 146. This action can be accomplished, for example, by executing the following pseudocode:

1) Create an empty “Aggregated Impact Table”. An Aggregated Impact Table is a collection of all “Impact Mappings”, defined below.

2) Merge the “Impact Tables” from the agents into the “Aggregated Impact Table”. For each “Impact Table” collected:

a. Write the “Impact Table” to a Database (e.g., the database 112) for use in report generation.

b. For each “Router IP Address” in an “Impact Table”:

i. Find an “Impact Mapping” in the “Aggregated Impact Table” entry that matches the “Router IP Address”.

ii. If NOT FOUND (“Impact Mapping”):

1. Create a new “Impact Mapping” entry for this router. Initialize it with the IP address of the router and set the “Aggregated Bit Rate” to zero, where the Aggregated Bit Rate is a value indicating the total bit rate of all streams from monitored streaming servers, that are directed to a single router interface as defined by an a router's IP address.

2. Create a new “Interface Entry”. Use “Router IP Address” and SNMP to retrieve router interface statistics from the router and save the statistics in the “Interface Entry”.

3. Add the “Interface Entry” to the “Impact Mapping”.

4. Add the “Impact Mapping” entry to the “Aggregated Impact Table”

iii. Create a new “Server Impact Entry” and initialize it with the name of the streaming server, the “Bit Rate” data, and the number of streams from the “Impact Table” entry currently being processed.

iv. Add the “Server Impact Entry” to the “Impact Mapping”

v. Add the “Bit Rate” value from the “Server Impact Entry” to the “Aggregated Bit Rate” value from the “Impact Mapping”.

vi. Add the Number of Streams value from the “Server Impact Entry” to the “Aggregated Stream” value from the “Impact Mapping”.

3) Free all “Impact Tables” as they are no longer needed.

4) Write the “Aggregated Impact Table” to a Database (e.g., the database 112) for use in report generation.

As used herein, an “Impact Mapping” is a mapping of a set of information to a specific router (e.g. a particular first-hop router). By way of example, the set of information can include or be defined as

Router-IP->(IF, AB, AS, I₍ᵢ₎, I₍ᵢ₊₁₎, I₍ᵢ₊ₙ₎)

Where, for example:

Router-IP is the “Router IP Address” of the router being analyzed.

IF is an “Interface Entry”. The IF is always the first object in the set. There is one and only one IF in each set.

AB is the “Aggregated Bit Rate”. AB is a numeric value. AB is the second object in the set. There is one and only AB in each set.

AS is the “Aggregated Stream” value. AS is the sum of the values in the Number of Streams entries of processed Impact Tables. AS is a numeric value, and is the third object in the set. There is one and only one AS in each set.

“I” is a “Server Impact Entry”.

“i” is an index.

“n” is the number of streaming servers that send streams through the specific router.

The order of the Router-IP set can be different from that shown above. In an exemplary embodiment, the order of the Router-IP set is consistent throughout the implementation.

In one example, “Server Impact Entry” is an object containing:

1) The name of a streaming server.

2) The total bit rate to a Router IP address for a streaming server.

3) The number of streams (Number of Streams) contributing to the total bit rate. This data can be taken from a row of an Impact Table.

In one example, “Interface Entry” is an object containing the following SNMP table items from the SNMP MIB (Management Information Base) “iso.org.dod.internet.mgmt.mib-2.interfaces.ifTable.ifEntry” on the router:

1) ifDescr: a description of the interface.

2) ifType: the type of the interface (Ethernet, Token Ring, etc.).

3) ifSpeed: the speed of the interface in bits per second.

Aggregated data can be analyzed in block 214. Block 214 can be encountered or reached, for example, from the aggregation block 212, in response to a Request for Updated Reports 222 from an Administrator or along any other appropriate path. In block 214, the data are analyzed to provide a comprehensive picture or indication of the complete effect on a router of all the media streams directed to that router. This effect can be reported for example to the administrator 202 (e.g., via the action 224). For example, the management server 102 can construct a Router Impact Set for a router based on information (e.g., in the form of impact tables) provided to the management server 102 by the agents 115, 125, 135. The Router Impact Set for a router can include, for example, a listing of the total number of media streams directed to the router, a total or combined data flow rate of those streams, and a measure of the router's or router interface's speed (e.g., maximum data flow rate). The Router Impact Set can also include a listing of streaming servers whose media streams are directed to the router, as well as for each of those streaming servers, a number of media streams directed from the streaming server to the router and a total data flow rate of streaming media directed to the router from that streaming server. The Router Impact Sets can be stored in the database 112.

Reports generated by the management server 102 can be graphical and/or tabular displays of data on computer screen or printout and can convey, for example, performance information or historical trends. The reports can be based on information newly received from the agents 115, 125, 135 and/or the routers 142, 144, 146, and/or can be based on data stored in the database 112.

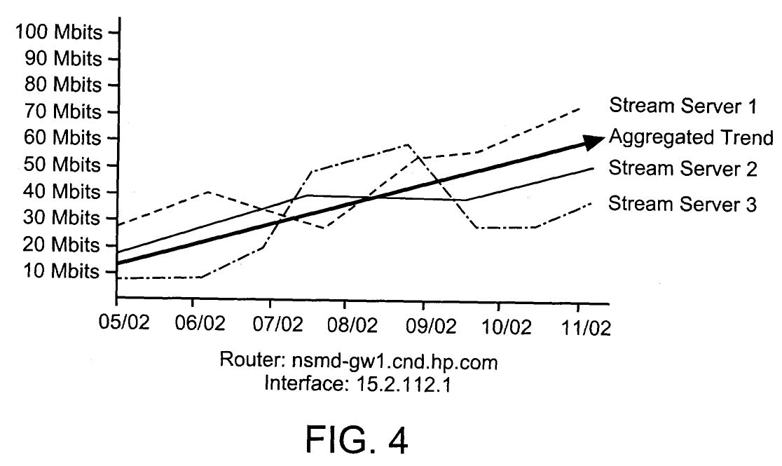

FIG. 4 shows an exemplary Router Interface Streaming Usage Report. In particular, FIG. 4 shows usage or load/production of stream or streaming servers 1, 2 and 3 over time. In other words, FIG. 4 shows data flow rates of streaming media emanating from the stream servers 1, 2 and 3 and passing through an interface of a router, for example an interface of a first-hop router, where the interface is labeled with an identifier “15.2.112.1” and the first-hop router is labeled with an identifier “nsmd-gw1.cnd.hp.com”. Time is indicated on the x-axis in terms of month and year, and data flow rate is indicated on the y-axis in terms of Megabits/second. FIG. 4 also shows an aggregated trend of usage of the stream servers 1, 2, 3.

Referring again to FIG. 2, threshold conditions or violations can also be checked. Based on the conditions or violations, a determination can be made in block 216 as to whether warnings or alerts should be generated. Based on the determination the warnings and/or alerts can be sent to the Administrator (e.g., via the action 226) or not sent (e.g., by transitioning from the block 216 to a “Do Nothing” block 218). Those skilled in the art will recognize these warnings and/or alerts can take various forms, and can refer to various problems or conditions that would be of interest to the Administrator. An alert can be issued, for example, a) when the combined data flow rate of all media streams directed to a router exceeds a specified percentage of the maximum speed of the router's interface, b) when the combined data flow rate of media streams directed to a router from a specific streaming server exceeds a specified percentage of the maximum speed of the router's interface, c) when the number of media streams directed to a router exceeds a specified number, and so forth.

An alert can be a text message, a synthesized voice message, a graphic, or any other message, that is sent to the Administrator and/or to a user or operator, and which conveys information about a change in the system. Alerts can be delivered in a variety of ways, including for example via a GUI (Graphical User Interface), a mobile phone, a pager, and so forth. An examplary alert indicating that a router interface is busy can take the following form:

Router Interface Busy Alert

Alert: Warning! Router Interface Busy

Date: Oct. 10, 2002 02:35PM

Description: Streaming media traffic through interface 15.2.112.1 on router nsmdgw1.cnd.hp.com is consuming 83% of the interface capacity. This exceeds the configured interface threshold of 50%.

Explanation: Streaming media traffic through the interface is being generated by streaming servers strmsvr1.cnd.hp.com (8 M-Bit Rate) and strmsvr8.cnd.hp.com (75 M-Bit Rate). Likely this is adversely impacting the access of other business network traffic through this router and users are probably experiencing delays.

Possible Cause: strmsvr8.cnd.hp.com is likely flooded with connections (current value 1256 clients) causing a large number of streams to be generated.

Possible Fix: strmsvr8.cnd.hp.com should be configured to limit the number of client connections to a maximum of 500.

The alert processing can be performed in block 214 and/or block 216, and can include, for example, execution of the following exemplary pseudocode:

1) Check for threshold violations in the “Aggregated Impact Table”. For each entry in the table:

a. Evaluate the threshold values against the “Aggregated Bit Rate” values. The specifics of the evaluation can be based on the threshold configurations made during the “Configuration” step.

b. If a threshold is violated then:

i. Generate an “Alert” to the administrator. The alert can be sent to a computer console, pager, mobile phone, or other device.

ii. Alert text can include one or more of the following:

1. Name

2. Severity

3. Date/Time

4. Threshold description

5. Explanation of the problem

6. Possible causes

2) If reports were configured during the “Configuration” step, then generate the required or desired reports.

3) Restart the timer for the next “Collection Processing”.

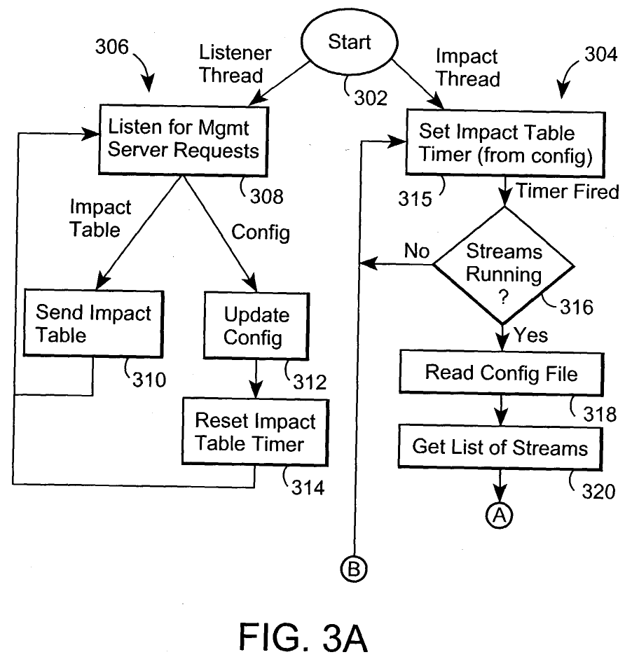

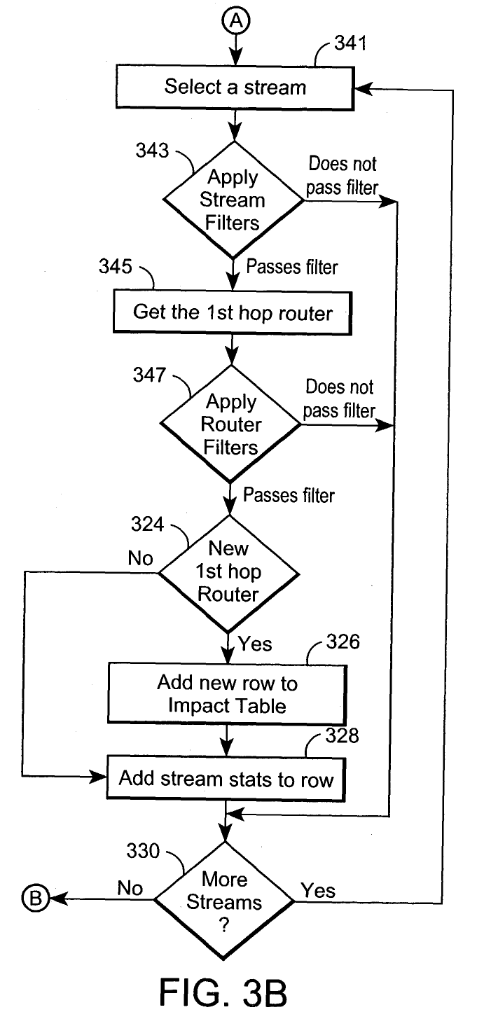

FIGS. 3A-3B show an exemplary logic or method that can be used or applied in each of the agents 115, 125, 135. From a start block 302, two threads can be started, an Impact Thread 304, and a Listener Thread 306. These threads can be run simultaneously or sequentially or in any harmonious fashion. For example, the listener thread 306 can be temporarily halted when the Impact Thread is actively assembling or updating an Impact Table, (e.g., after the Impact Table Timer has fired and before it is reset). If the very freshest information is desired or requested, the Listener Thread 306 can set the Impact Table Timer in the Impact Thread 304 to zero (or otherwise fired before its interval expired), to immediately trigger the data-gathering process of the Impact Thread. Those skilled in the art will recognize that many other variations are possible and consistent with principles and operations described herein.

In the Listener Thread 306, in block 308 the agent listens for requests or communications from the management server 102; for example a request to send information regarding media streams (e.g., a latest version of an Impact Table maintained by the agent), or configuration information from the management server 102. Thus, when the agent receives an information request from the management server 102, the agent can send the current impact table to the management server (block 310) and then return to listening (block 308). In an exemplary embodiment, the request can direct the agent to return the current impact table, or can direct the agent to make and send a fresh impact table, for example by triggering the Impact Table Timer before its time interval has expired to cause the Impact Thread 304 to make the fresh impact table. When the agent receives configuration information from the management server 102, the agent can update its configuration (block 312) and reset an impact table timer (block 314), and then return to listening (block 308).

In the Impact Thread 304, in a first block 315 the agent sets an impact table timer in accordance with data or a timing interval consistent with the agent's configuration. For example, the impact table timing interval can be part of the configuration information sent or provided to the agent, for example by the management server 102. When the impact table timing interval expires (i.e., the timer fires), then control moves to block 316 where a determination is made whether there are any media streams emanating from the streaming server that the agent is monitoring. If no, then control returns to block 315. If yes, then control proceeds to block 318, where the agent reads its configuration file to obtain and load filters relating to the stream server and the routers that the stream server may communicate with. From block 318, control proceeds to block 320, where the agent obtains a list from the streaming server of media streams emanating from the streaming server. In block 320, an empty “Impact Table” can also be created, or an existing Impact Table can be emptied, for example to get rid of any listings for media streams no longer emanating from the streaming server.

From block 320, control proceeds to block 341, where the agent selects one of the streams in the list. From block 341, control proceeds to block 343, where stream filters are applied. If the selected stream does not pass the stream filters, then control proceeds to block 330 where a determination is made if there are more streams emanating from the streaming server, that have not yet been selected. If yes, then control returns from block 330 to block 341 where another media stream is selected from the list and the process repeats. If no, then control returns from block 330 to block 315.

If in block 341 the selected stream does pass the stream filters, then control proceeds to block 345, which determines the first-hop router for the selected stream (for example, by consulting a route table or routing table in the streaming server using the selected stream's destination IP address). From block 345 control proceeds to block 347, where router filters are applied. If the determined first-hop router does not pass the router filters, then control proceeds to block 330. If the determined first-hop router does pass the router filters, then control proceeds to block 324.

In block 324 the agent determines whether the determined first-hop router is new. For example, if the media stream passes the stream filters and the router obtained from the routing table passes the router filters, then the router is a new first-hop router and control proceeds to block 326 where a new row is added to the impact table. The new row can be initialized with the IP address of the new first-hop router. From block 326, control proceeds to block 328. If either the media stream or the router does not pass the filters in block 324, then control proceeds from block 324 to block 328.

In block 328, statistics regarding the media stream are added or updated to the row of the Impact Table corresponding to the first-hop router. For example, the number of media streams directed to the first-hop router can be incremented, and the bit rate or data transfer rate of the media stream can be added to the total streaming media transfer rate of known streams directed to the first-hop router. From block 328, control proceeds to block 330 where a determination is made if there are more streams emanating from the streaming server, that have not yet been selected. If yes, then control returns to block 341 where another media stream is selected from the list and the process repeats. If no, then control returns to block 315.

In an exemplary embodiment, the block 343, and/or the block 347 can be omitted.

In an exemplary embodiment, the agent can also query first-hop routers directly to obtain information about the routers, for example a maximum speed or capacity of the routers' interfaces, and can add this information to the Impact Table (e.g., to a column labeled Interface Speed).

The pseudocode sequences, methods, logics and techniques described herein for performing or implementing various features, can be implemented in a variety of programming styles (for example Structured Programming, Object-Oriented Programming, and so forth) and in a variety of different programming languages (for example Java, C, C++, C#, Pascal, Ada, and so forth).

Those skilled in the art will appreciate that the elements and methods or processes described herein can be implemented using a microprocessor, computer, or any other computing device, and can be implemented in hardware and/or software, in a single physical location or in distributed fashion among various locations or host computing platforms. The agents can be implemented in hardware and/or software at any desired or appropriate location.

It will be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope is indicated by the appended claims rather than the foregoing description, and all changes that come within the meaning and range and equivalents thereof are intended to be embraced therein.

1. A method for monitoring data flow to a router having an interface configured to receive media streams, comprising:
identifying media streams directed to the interface; and
determining whether a combined data flow rate of the identified media streams exceeds a threshold.

2. The method of claim 1, wherein the identifying includes receiving information from a streaming server regarding media streams emanating from the streaming server.

3. The method of claim 2, wherein the information from the streaming server includes, for each stream emanating from the streaming server, a router destination and a flow rate.

4. The method of claim 3, wherein the router destination is obtained from a route table of the streaming server.

5. The method of claim 3, wherein the flow rate is a number of bits per second at which the stream is sending information.

6. The method of claim 3, wherein the router destination includes an Internet Protocol address of a router.

7. The method of claim 3, comprising:
determining the threshold based on a speed of the interface.

8. The method of claim 7, wherein the threshold is a speed of the interface.

9. The method of claim 7, wherein the threshold is a fraction of the speed of the interface.

10. The method of claim 7, wherein the router is a first-hop router with respect to the streaming server.

11. The method of claim 1, comprising:
determining what portion of the interface capacity is consumed by the media streams.

12. The method of claim 11, comprising:
indicating a time at which the determined portion of the interface's capacity is consumed by the media streams.

13. The method of claim 11, comprising:
indicating an average portion of the interface's capacity that is consumed by the media streams over a time interval.

14. The method of claim 1, wherein the identifying and determining are repeated performed periodically.

15. The method of claim 1, wherein the identifying and determining are performed upon occurrence of a predetermined condition.

16. A system for monitoring data flow to a router having an interface configured to receive media streams, the system comprising:
an agent arranged to identify media streams directed to the interface; and
a device arranged to receive information regarding media streams identified by the agent, from the agent and to determine whether a combined data flow rate of the identified media streams exceeds a threshold.

17. The system of claim 16, wherein the device is a management server.

18. The system claim 16, wherein the information regarding media streams identified by the agent includes, for each media stream emanating from the streaming server, a router destination and a flow rate.

19. The system of claim 18, wherein the agent obtains the router destination from a route table of the streaming server.

20. The system of claim 18, wherein the router destination includes an Internet Protocol address of a router.

21. A machine readable medium including software for causing a computing device to perform a method for monitoring data flow to a router having an interface configured to receive media streams, the method comprising:
identifying media streams directed to the interface; and
determining whether a combined data flow rate of the identified media streams exceeds a threshold.

22. The machine readable medium of claim 21, the method comprising:
receiving information from at least one streaming server regarding media streams emanating from the at least one streaming server.

23. The machine readable medium of claim 22, the method comprising: determining the threshold based on a speed of the interface.

24. The machine readable medium of claim 23, the method comprising:
determining what portion of the interface capacity is consumed by the media streams.

25. The machine readable medium of claim 24, the method comprising:
indicating a time at which the determined portion of the interface's capacity is consumed by the media streams.

26. The machine readable medium of claim 25, the method comprising:
indicating an average portion of the interface's capacity that is consumed by the media streams over a time interval.

27. A system for monitoring streaming media flow to a router having an interface configured to receive media streams, the system comprising:
a plurality of means for collecting information associated with streaming servers, the information including destination and flow rate information about media streams emanating from the streaming servers;
means for determining based on the collected information, a combined data flow rate of all identified media streams directed to the interface; and
means for determining whether the combined data flow rate exceeds a threshold.

28. The system of claim 27, comprising:
means for determining what portion of the interface capacity is consumed by the combined data flow rate.

29. The system of claim 28, comprising:
means for indicating a time at which the determined portion of the interface's capacity is consumed by the combined data flow rate.

30. The system of claim 29, comprising:
means for indicating an average portion of the interface's capacity that is consumed by the combined data flow rate over a time interval.

31. The system of claim 27, comprising:
means for determining what portion of the combined data flow rate emanates from a particular one of the streaming servers.

32. The system of claim 27, comprising:
means for determining a contribution of each streaming server to the combined data flow rate.
